(19) United States
(12) Patent Application Publication
(10) Pub. No.: US 2011/0249331 A1
(43) Pub. Date: Oct. 13, 2011

(54) Method and Arrangement for Spatial Display

(75) Inventors: Markus KLIPPSTEIN, Jena (DE); Stephan OTTE, Jena (DE)

(73) Assignee: 3D INTERNATIONAL EUROPE GMBH, Jena (DE)

(21) Appl. No.: 13/163,961

(22) Filed: Jun. 20, 2011

Related U.S. Application Data
(63) Continuation of application No. PCT/DE2009/050010, filed on Feb. 26, 2009.

(30) Foreign Application Priority Data
Dec. 19, 2008 (DE) 10 2008 062 790.9

(51) Int. Cl. G02B 27/22

(52) U.S. Cl. 359/464

(57) ABSTRACT

The invention relates to a method and an arrangement for spatial display, in particular to a display that can be perceived in three dimensions simultaneously by several viewers without viewing aids, also known as autostereoscopic visualization. With the invented method, bits of partial information from different views A(k) with k=1, . . . , n and n>1 are made visible on a grid (1) of pixels x(i,j) with rows (i) and columns (j), and at least one parallax barrier screen (2) is arranged in front of or behind the grid (1) of pixels x(i,j) at a distance s, which contains at least semitransparent segments, the segments corresponding essentially to stripes delimited by straight-line edges, which run uninterruptedly from one margin of the parallax barrier screen (2) to an opposite or adjoining margin, so that one or several viewers (3), because of the viewing restriction effected by the at least one parallax barrier screen (2), will see at least partially different pixels x(i,j) and/or parts thereof with each of their two eyes (3a, 3b), so that each of the two eyes (3a, 3b) perceives at least partially different views A(k) and, thus, a spatial visual impression results.

### RELATED APPLICATIONS

This Application is a Continuation application of International Application PCT/DE2009/050010, filed on Feb. 26, 2009, which in turn claims priority to German Patent Application No. DE 10 2008 062 790.9, filed Dec. 19, 2008, both of which are incorporated herein by reference in their entirety.

### FIELD OF THE INVENTION

The invention relates to the field of spatial display, in particular to a display that can be perceived in three dimensions simultaneously by several viewers without viewing aids, also known as autostereoscopic visualization.

### BACKGROUND OF THE INVENTION

Approaches to the said field have been existing for quite some time. Frederic Ives, a pioneer in this field, presented a system with a “line screen” for 3D display in GB 190418672 A. The article “Theory of parallax barriers” by Sam H. Kaplan, Journal of SMPTE Vol. 59, No 7, pp 11-21, July 1952, describes fundamental findings about the use of barrier screens for 3D display.

Attempts to gain autostereoscopic systems widespread use were unsuccessful for a long time, though. It was not until the 1980s that the computing power and novel display technologies then available made possible some renaissance of 3D systems. In the 1990s, the number of patent applications for, and publications on, 3D visualizations without stereo goggles soared. Outstanding results were achieved by the following inventors or suppliers:

In JP 08331605 AA, Masutani Takeshi et al. describe a stepped barrier, in which a transparent barrier element has approximately the size of a color subpixel (R, G or B). This technology made it possible for the first time to partially divert to the vertical direction the horizontal resolution loss occurring in most autostereoscopic systems due to the simultaneous display of several (at least two, preferably more than two) views. Here just as with all barrier methods, the disadvantage is the high light loss. Also, as the viewer moves sideways, the stereo contrast changes from almost 100% to about 50% and then again increases to 100%, which leads to a fluctuating 3D image quality in the viewing space.

With his teachings according to U.S. Pat. No. 5,808,599, U.S. Pat. No. 5,936,607 and WO 00/10332 A1, Pierre Allio succeeded in making a remarkable advancement of lenticular technology, in which he also uses a subpixel-based division of views.

A patent on another outstanding result was applied for by Cees van Berkel with EP 791 847 A1. Here, lenticular lenses inclined from the vertical are overlaid on a display that also shows different perspective views. Characteristically, n views are distributed to at least two screen rows, so that again the resolution loss is partially diverted from the horizontal to the vertical.

However, lenticular lenses are complicated to produce, and the process of manufacturing a 3D display based on them is untrivial.

With U.S. Pat. No. 6,157,424 and WO 02/35277 A1 and a number of other inventions, Jesse Eichenlaub set several milestones for autostereoscopy.

With DE 100 03 326 C2, Armin Grasnick et al. succeeded in advancing the barrier technology with regard to two-dimensionally structured, wavelength-selective filter arrays for creating a 3D impression. This solution also suffers from the greatly impaired brightness of such 3D systems compared to a 2D display.

With WO 2005/027534 A2, Armin Schwerdtner succeeded in finding an innovative technological approach to a 3D display with full resolution in all (as a rule, two) views. However, this approach involves a great deal of adjustment work, and it is extremely difficult to implement for greater screen diagonals (of approx. 25 inches and greater).

### SUMMARY OF THE INVENTION

The present invention is based on the problem of creating a way of autostereoscopic display on the basis of the barrier technology, in order improve perceptibility for several viewers at a time. Improved perceptibility means, especially but not limited to, improved brightness simultaneously with the best possible stereo channel separation.

According to the invention, this problem is solved by a method for spatial display, in which
bits of partial information from different views A(k) with k=1, . . . , n and n>1 are made visible on a grid 1 of pixels x(i,j) with rows i and columns j, and
arranged in front of or behind the grid 1 of pixels x(i,j) at a distance s is at least one parallax barrier screen 2, which has segments of different transmission behavior delimited by edges, at least one of which segments is made semitransparent, with the edges being arranged in parallel and running from one margin of the parallax barrier screen to an adjoining or opposite margin,
so that one or several viewers 3, because of the viewing restriction effected by the at least one parallax barrier screen 2, will see at least partially different pixels x(i,j) and/or parts thereof with each of their two eyes, so that each of the two eyes perceives at least partially different views A(k) and, thus, a spatial visual impression results.

The new method opens up novel, advantageous means-and-effect relationships. Firstly, the use of not only transparent and opaque segments, as common in prior art, enables a much softer transition between the views A(k) seen by the viewer when he moves sideways. Secondly, in many embodiments of the invention, the use of semitransparent segments running uninterruptedly from one margin of the parallax barrier screen to an opposite or adjacent margin ensures that the viewer or viewers, if seeing only parts of some pixels x(i,j) (rather than the complete pixel) because of the viewing restriction effect, will not always see such a part of a pixel x(i,j) with its full brightness. Thereby, the visual resolution and the stereo channel separation are improved.

Compared to a usual barrier with only opaque and transparent segments, the invention makes it possible to increase brightness, e.g., by providing semitransparent segments around the usual transparent segments without noticeably impairing stereo channel separation.

Because the parallax barrier screen is provided also with semitransparent segments, unpleasant moiré effects that may arise, say, in exposing a photographic film as a barrier structure, can be avoided. Furthermore, the embodiment of the parallax barrier screen according to the invention helps avoid, or at least greatly minimize, visual superpositions, i.e., moiré effects again, that may arise due to the observation of the grid of pixels through the parallax barrier screen. This is effected in such a way that, due to the semitransparent segments, the usually given periodic distances between opaque segments are changed so that visually different—as a rule, periodic—distances result, which lead to less strong or even no moiré effects.

The segments may have shapes other than stripes, such as, e.g., wedges or trapezoids.

In the invented method, the bits of partial information from different views A(k) are advantageously arranged on the grid of pixels x(i,j) in a two-dimensional periodic pattern, with the period lengths in the horizontal and vertical directions preferably comprising not more than 32 pixels x(i,j) each. Exceptions from this upper limit of 32 pixels x(i,j) each are permissible.

Particular embodiments of the rendition of partial image information, as described, e.g., in DE 101 45 133 C1, are also possible.

Preferably, the vertical period length is equal to the number n of the views displayed. This number of views may be, for example, 2, 3, 4, 5, 6, 7, 8, 9 or more.

For all the following embodiments, exactly one parallax barrier screen is assumed, although for certain applications several such parallax barrier screens may be of advantage.

Furthermore, the pixels x(i,j) each correspond to single color subpixels (R, G or B) or clusters of color subpixels (e.g., RG, GB or RGBR or others) or full-color pixels, the term full-color pixels meaning both white-mixing structures of RGB color subpixels, i.e. RGB triplets, and—depending on the image generation technology—actual full-color pixels, as frequently used, say, in projection screens.

The semitransparent segments are preferably designed as neutral density filters or neutral density step filters, especially for the essentially wavelength-independent attenuation of light intensity. It may be of particular advantage to design the semitransparent segments in such a way that they have a locus-dependent transmittance. Such neutral density filters or neutral density step filters can be made, e.g., using so-called dithering methods with exclusively opaque and transparent partial areas. This means that the effect of a particular gray level is achieved by the arrangement, defined by dithering, of merely opaque dots or other small-area patterns rather than having to homogeneously provide the entire segment with a corresponding gray level. The latter is of advantage especially if the neutral density step filters or neutral density filters are to be made by exposure methods that can only produce opaque or transparent states.

Advantageously, at least one transparent segment on the parallax barrier screen adjoins a semitransparent segment. Alternatively, it is possible that the sequence of the segments on the parallax barrier screen is periodically

opaque

semitransparent

transparent

semitransparent

opaque

semitransparent

transparent

semitransparent,

etc.

Another advantageous sequence of the segments on the parallax barrier screen is periodically

opaque

semitransparent

opaque

transparent

opaque

semitransparent

opaque

transparent

opaque, etc.

It is furthermore possible to have a sequence of the segments on the parallax barrier screen that is periodically

opaque

transparent

semitransparent

opaque

transparent

semitransparent

opaque

transparent

semitransparent etc.,

or vice versa.

In another embodiment, the sequence of the segments on the parallax barrier screen is periodically

opaque

semitransparent with a first transmittance

semitransparent with a second transmittance

transparent

semitransparent with the second transmittance

semitransparent with the first transmittance

opaque, etc.

The first transmittance might be, e.g., 33%, the second one 66%. Besides, “transparent” would mean a transmittance of close to 100%, which, for technical reasons, is attained only approximately in most cases.

Finally it is possible that at least three types of semitransparent segments with different transmittances are provided on the parallax barrier screen. For example,

opaque

semitransparent with a first transmittance

semitransparent with a second transmittance

semitransparent with a third transmittance

transparent

semitransparent with the third transmittance

semitransparent with the second transmittance

semitransparent with the first transmittance

opaque, etc.

Here, the first transmittance might be 20%, the second one 40%, the third one 80%, or the first one 25%, the second one 49%, the third one 74%. Many other sensible configurations are possible.

Alternatively, the above configuration can be varied as follows:

opaque

semitransparent with the first transmittance

semitransparent with the third transmittance

semitransparent with the second transmittance

transparent

semitransparent with the second transmittance

semitransparent with the third transmittance

semitransparent with the first transmittance

opaque, etc.

Such variations serve to reduce optical superpositions.

For certain applications, e.g., to avoid moiré effects, one transparent or one semitransparent segment may be arranged each between two opaque segments with a statistical distribution on the parallax barrier screen. This means that the selection of a transparent or semitransparent segment is made at random.

Advantageously, given parallel projection of the parallax barrier screen 2 onto the grid 1 of pixels x(i,j), the transparent and the semitransparent segments are essentially inclined by −90 . . . +90 (including 0) degrees from the vertical direction of the grid of pixels x(i,j), the inclination of zero degrees being, of course, no true inclination but corresponding to the vertical direction.

The transparent segments may have, on an average, a width equal to or different from the width of the semitransparent segments. In advantageous embodiments, the sum of the semitransparent segments will be greater than that of the transparent segments, in order to achieve the best possible stereo channel separation, i.e. a reduced mix of different views per eye.

Furthermore, at least one semitransparent segment on the parallax barrier screen 2 may have stepped or continuous changes of the transmittance, especially in the longitudinal direction of the respective segment. This embodiment also permits the reduction of, e.g., moiré effects.

As a rule, the angle that constitutes the said horizontal and vertical period length of the said two-dimensional periodic pattern as opposite leg and adjacent leg should essentially correspond to the average angle of inclination a of the transparent and the semitransparent segments on the parallax barrier screen 2 relative to the vertical.

In this way, the best channel separation in 3D display is achieved. In other words, the edges limiting the segments all run in parallel at the angle a. It is also possible, though, for adjacent edges not to run parallel to each other.

Just as with various other 3D display methods, the views A(k) correspond to different perspectives of a scene or object. The views A(k) may correspond to still images or sequences of moving images.

The parameters for the parallax barrier screen 2 can be easily computed with the aid of the two equations (1) and (2) known from Kaplan's article mentioned at the beginning. This establishes all necessary relations between the distance s of the grid of pixels x(i,j) from the parallax barrier screen 2, the average human interpupillary distance (typically 65 mm), the viewing distance, the (horizontal) period length of the transparent or semitransparent segments of the barrier, and the possible stripe width of the said transparent or semitransparent segments. The stripe width may also be increased or decreased relative to a value thus determined.

The following should be noted regarding the period of the structure used on the parallax barrier screen 2:

The said horizontal and vertical period length of the said two-dimensional periodic pattern (of arrangement of the views A(k) on the grid 1) should preferably agree with the respective horizontal and vertical period lengths of the transparent segments of the parallax barrier screen 2, save for a correction factor y, with 0.98<y<1.02. Where appropriate, the horizontal or vertical period length of the transparent segments may be understood to be the average horizontal or vertical distance, respectively, of the same.

In principle, the semitransparent and the transparent segments may also be arranged on the parallax barrier screen 2 in a manner that is not strictly periodic, e.g., by varying the widths and/or the transmittance.

For special embodiments it may be useful that the invented method does not contain any completely opaque segments.

In that respect, some of the semitransparent segments might replace the opaque segments, e.g. if these have a low transmittance though greater than 0, e.g., 1%, 2% or 3%.

The problem of the invention is furthermore solved by an arrangement for spatial display, comprising
an image display device with pixels x(i,j) in a grid 1 with rows i and columns j, on which bits of partial information from different views A(k) with k=1, . . . , n and n>1 can be made visible,
at least one parallax barrier screen 2 arranged in front of or behind the grid 1 with pixels x(i,j) at a distance s, which has segments of different transmission behavior delimited by edges, at least one of which segments is made semitransparent, with the edges running from one margin of the parallax barrier screen 2 to an adjoining or opposite margin,
so that one or several viewers 3, because of the viewing restriction effected by the at least one parallax barrier screen 2, will see at least partially different pixels x(i,j) and/or parts thereof with each of their two eyes 3a, 3b, so that each of the two eyes perceives at least partially different views A(k) and, thus, a spatial visual impression results.

The assignment of the bits of partial information from different views A(k) to the pixels x(i,j) preferably follows a two-dimensional periodic pattern, with the period length in the horizontal and vertical directions preferably comprising not more than 32 pixels x(i,j) each. In particular application cases, the image interweaving rule could be adapted to the form of the transparent segments.

Here again, at first only one parallax barrier screen 2 is assumed in the following. The number of views n may be, for example, 2, 3, 4, 5, 6, 7, 8, 9 or more. If, for example, the number of the views A(k) n=5, the said horizontal period length may correspond to 5 pixels x(i,j).

Preferably, but not necessarily, the vertical period length is equal to the number of views displayed.

Furthermore, the pixels x(i,j) each correspond to single color subpixels (R, G or B) or clusters of color subpixels (e.g., RG, GB or RGBR or others) or full-color pixels, the term full-color pixels meaning both white-mixing structures of RGB color subpixels, i.e. RGB triplets, and—depending on the image generation technology—actual full-color pixels, as frequently used, e.g., in projection screens.

The semitransparent segments are preferably designed as neutral density filters or neutral density step filters, especially for the essentially wavelength-independent attenuation of light intensity. Such neutral density filters or neutral density step filters can be made, e.g., using so-called dithering methods with exclusively opaque and transparent partial areas. This means that the effect of a particular gray level is achieved by the arrangement, defined by dithering, of merely opaque dots or other small-area patterns rather than having to use dots or patterns of a particular gray level. The latter is of advantage especially if the neutral density step filters or neutral density filters are to be made by exposure methods that can only produce opaque or transparent states.

Advantageously, at least one transparent segment on the parallax barrier screen 2 adjoins a semitransparent segment. Alternatively, it is possible that the sequence of the segments on the parallax barrier screen is periodically

opaque

semitransparent

transparent

semitransparent

opaque

semitransparent

transparent

semitransparent,

etc.

Another advantageous sequence of the segments on the parallax barrier screen 2 is periodically

opaque

semitransparent

opaque

transparent

opaque

semitransparent

opaque

transparent

opaque, etc.

It is furthermore possible to have a sequence of the segments on the parallax barrier screen 2 that is periodically

opaque

transparent

semitransparent

opaque

transparent

semitransparent

opaque

transparent

semitransparent, etc., or vice versa.

In another embodiment, the sequence of the segments on the parallax barrier screen 2 is periodically

opaque

semitransparent with a first transmittance

semitransparent with a second transmittance

transparent

semitransparent with a second transmittance

semitransparent with a first transmittance

opaque, etc.

Finally it is possible that at least three types of semitransparent segments with different transmittances are provided on the parallax barrier screen 2. For example,

opaque

semitransparent with a first transmittance

semitransparent with a second transmittance

semitransparent with a third transmittance

transparent

semitransparent with a third transmittance

semitransparent with a second transmittance

semitransparent with a first transmittance

opaque, etc.

Here, the first transmittance might be 20%, the second one 40%, the third one 80%, or the first one 25%, the second one 49%, the third one 74%. Many other sensible configurations are possible.

Alternatively, the above configuration can be varied as follows:

opaque

semitransparent with a first transmittance

semitransparent with a third transmittance

semitransparent with a second transmittance

transparent

semitransparent with a second transmittance

semitransparent with a third transmittance

semitransparent with a first transmittance

opaque, etc.

Such variations serve to reduce optical superpositions.

For certain applications, e.g., to avoid moiré effects, one transparent or one semitransparent segment may be arranged each between two opaque segments with a statistical distribution on the parallax barrier screen 2. This means that the selection of a transparent or semitransparent segment is made at random.

Advantageously, given parallel projection of the parallax barrier screen 2 onto the grid 1 of pixels x(i,j), the transparent and the semitransparent segments are essentially inclined by −90 . . . +90 (including 0) degrees from the vertical direction of the grid of pixels x(i,j), the inclination of zero degrees being, of course, no true inclination but corresponding to the vertical direction.

Furthermore, the transparent segments may have, on an average, a width equal to or different from the width of the semitransparent segments. The variation of the width again permits both reducing moiré effects and influencing the stereo contrast.

Furthermore, at least one semitransparent segment on the parallax barrier screen 2 may have stepped or continuous changes of the transmittance. This embodiment also permits the reduction of, e.g., moiré effects.

As a rule, the angle that constitutes the said horizontal and vertical period length of the said two-dimensional periodic pattern as opposite leg and adjacent leg should essentially correspond to the average angle of inclination a of the transparent and the semitransparent segments on the parallax barrier screen 2 relative to the vertical. In this way, the best channel separation in 3D display is achieved. In other words, the edges limiting the segments all run in parallel at the angle a. It is also possible, though, for adjacent edges not to run parallel to each other. Further it should be noted that the edges are essentially straight-lined. This is not mandatory, though, as alternatively the edge shape may be stair-like, or a line meandering about a straight line.

The views A(k) may correspond to different perspectives of a scene or object. Also, the views A(k) may be still images or sequences of moving images.

The image display device may preferably be a color LCD screen, a plasma display, a projection screen, an LED-based screen, an SED screen or a VFD screen.

Preferably, the parallax barrier screen 2 consists of a glass substrate with the barrier structure applied onto its rear side. The said barrier structure is, for example, an exposed and developed sheet of photographic film laminated to the rear side of the glass substrate, with the emulsion layer of the photographic film preferably facing the glass substrate. Alternatively, the opaque areas of the barrier structure may be formed by ink or pigments applied onto the glass substrate (e.g., by printing).

Furthermore, the parallax barrier screen 2 advantageously comprises means for reducing disturbing light reflections, preferably at least one interference-optical antireflection coat. It is also possible, though, to use common antiglare matting.

The parallax barrier screen 2 is permanently mounted, e.g., bonded or screwed, to the image display device by means of a spacer.

The following should be noted regarding the period of the structure used on the parallax barrier screen 2:

The said horizontal and vertical period length of the said two-dimensional periodic pattern (of arrangement of the views A(k) on the grid 1) should preferably agree with the respective horizontal and vertical period lengths of the transparent segments of the parallax barrier screen 2, save for a correction factor y, with 0.98<y<1.02. Where appropriate, the horizontal or vertical period length of the transparent segments may be understood to be the average horizontal or vertical distance, respectively, of the same.

### BRIEF DESCRIPTION OF THE DRAWINGS

Below, the invention will be explained in more detail in exemplary embodiments and with reference to the accompanying drawings in which:

FIG. 1 shows the schematic setup for implementing the invented method,

FIG. 2 through FIG. 6 and FIG. 11 each show the schematic structure of a parallax barrier screen 2 for use in the invented method,

FIG. 7 shows an example of an image combination of the bits of partial information from different views,

FIG. 8 shows viewing examples for a first viewer eye, based on the relationships in FIGS. 2 and 7,

FIG. 9 shows viewing examples for a second viewer eye, based on the relationships in FIGS. 2 and 7, and

FIG. 10 schematically illustrates the generation of the spatial impression according to the invented method.

### DETAILED DESCRIPTION OF THE PREFERRED EMBODIMENTS

None of the drawing is made to scale. This also, and in particular, applies to angular dimensions.

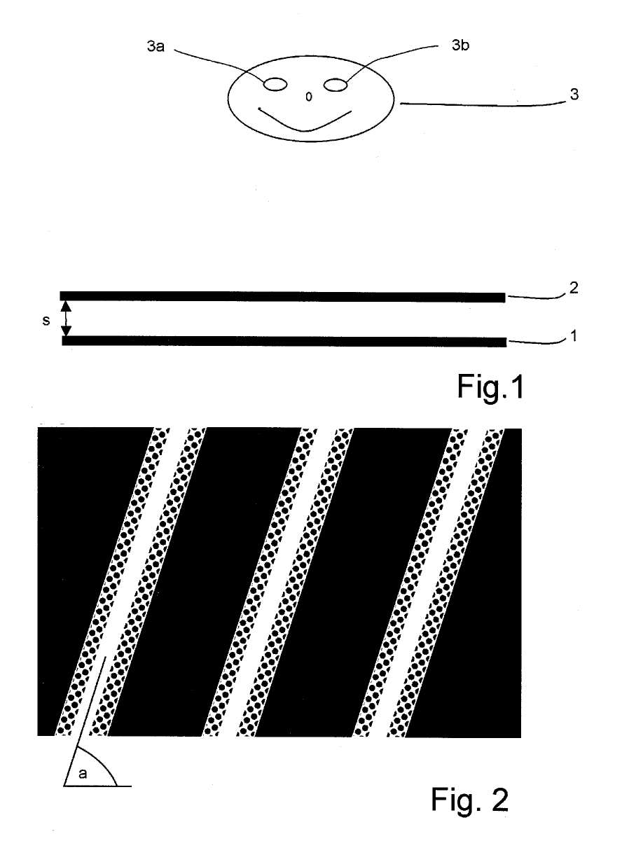

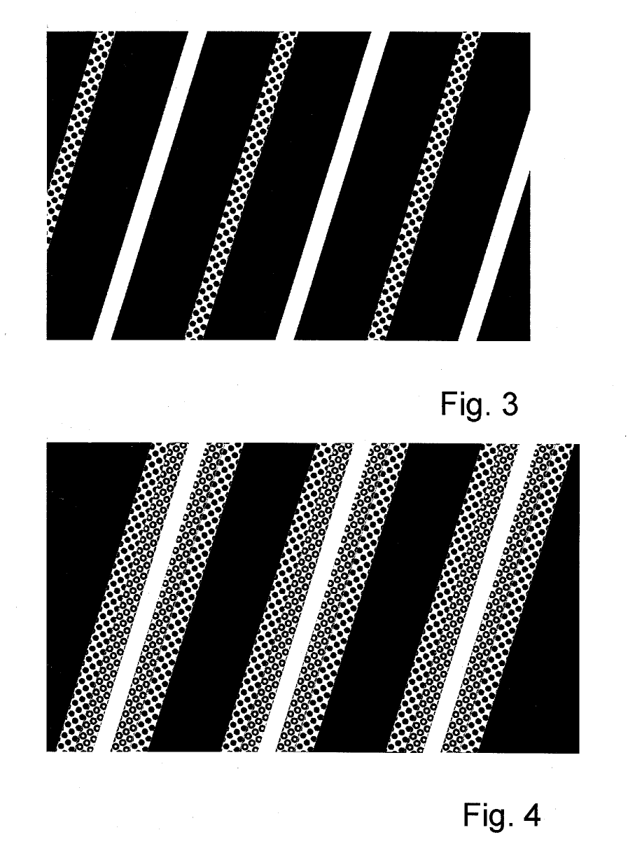

FIG. 1 shows the schematic setup for implementing the invented method for spatial display. On the grid 1 of pixels x(i,j) with rows i and columns j, bits of partial information from different views A(k) with k=1, . . . , n and n>1 are made visible. Arranged in front of the grid 1 of pixels x(i,j) at a distance s is a parallax barrier screen 2, which contains opaque, semitransparent and transparent segments, with the transparent and the semitransparent segments essentially corresponding to stripes that are delimited by straight-line edges, which run uninterruptedly from one margin of the parallax barrier screen 2 to an opposite margin. An example of such a parallax barrier screen 2 is shown as a sectional view in FIG. 2.

Because of the viewing restriction effected by the at least one parallax barrier screen 2, the two eyes 3a, 3b of one or several viewers 3 will see at least partially different pixels x(i,j) and/or parts thereof, so that each of the two eyes 3a, 3b perceives at least partially different views A(k), which results in a spatial visual impression.

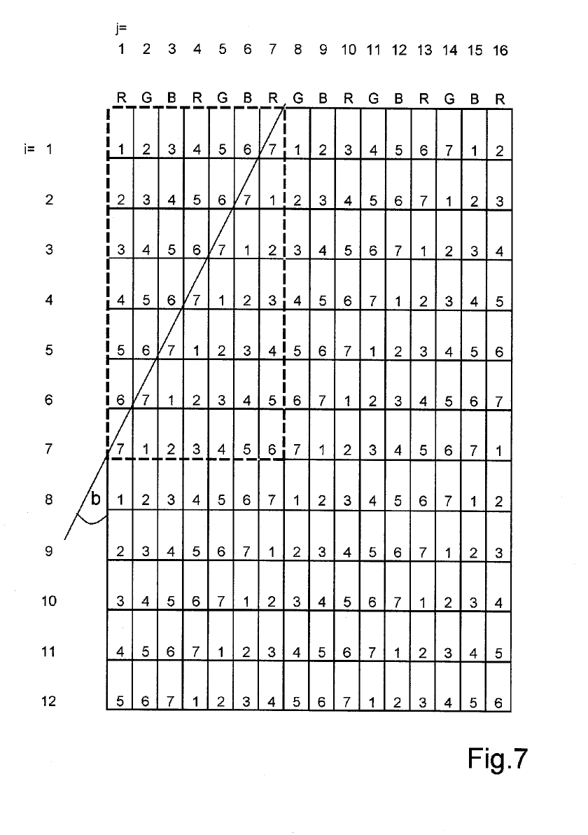

According to the invented method, the bits of partial information from different views A(k) on the grid of pixels x(i,j) are advantageously arranged in a two-dimensional periodic pattern, as suggested in FIG. 7. Here, the number of views n=7. The vertical and also the horizontal period length of the said periodic pattern is equal to the number n=7 of the views displayed; this is indicated by the broken line. Numbers other than n=7 are possible, of course.

Further, the pixels x(i,j) each correspond to single color subpixels (R, G or B); the grid 1 may be implemented by a color LC display, for example.

The semitransparent segments are designed as neutral density filters, especially for the essentially wavelength-independent attenuation of light intensity.

In the example of FIG. 2, the sequence of the segments on the parallax barrier screen 2 is periodically

opaque

semitransparent

transparent

semitransparent

opaque

semitransparent

transparent

semitransparent

etc.

As shown in FIG. 3, another advantageous sequence of the segments on the parallax barrier screen 2 is periodically

opaque

semitransparent

opaque

transparent

opaque

semitransparent

opaque

transparent

opaque etc.

In another embodiment, as shown in FIG. 4, the sequence of the segments on the parallax barrier screen 2 is periodically

opaque

semitransparent with a first transmittance

semitransparent with a second transmittance

transparent

semitransparent with a second transmittance

semitransparent with a first transmittance

opaque, etc.

The first transmittance might be, e.g., 33%, the second one 66%. Besides, “transparent” would mean a transmittance of close to 100%, which, for technical reasons, will certainly be reached only approximately in most cases. Also, the first transmittance might be 20%, the second one 40%, and a third one 80% , or the first one 25%, the second one 49%, and the third one 74%. Many other sensible configurations are possible.

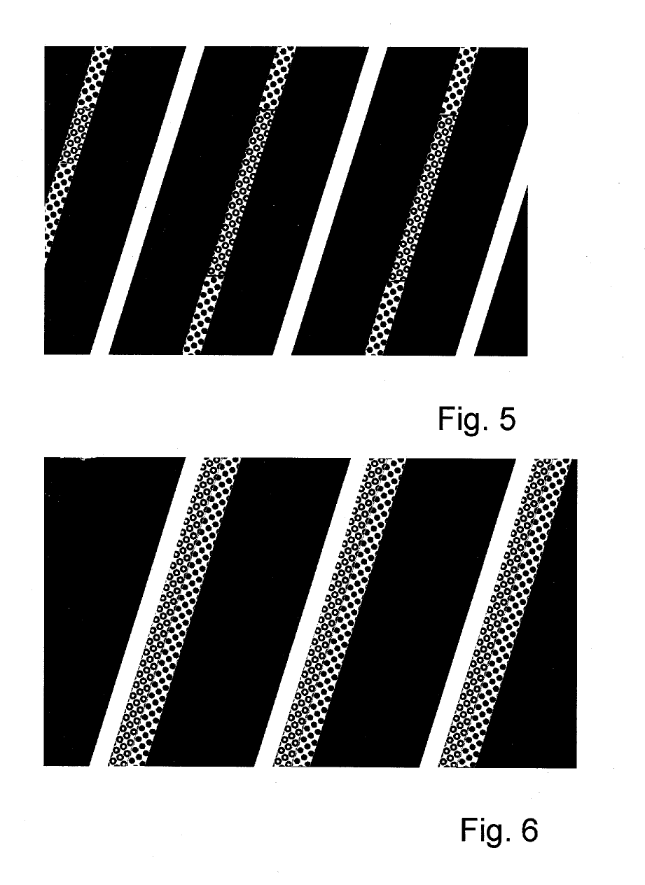

As shown in FIG. 5, at least one semitransparent segment on the parallax barrier screen 2 may exhibit stepped or continuous variations of transmittance, especially in the longitudinal direction of the respective segment. This embodiment also permits, e.g., moiré effects to be at least reduced.

In another example, as shown in FIG. 6, the sequence of the segments on the parallax barrier screen 2 is periodically

opaque

transparent

semitransparent with a second transmittance

semitransparent with a first transmittance

opaque

transparent

semitransparent with a second transmittance

semitransparent with a first transmittance

etc.

For the materialization of the spatial impression, we refer, e.g., to a parallax barrier screen 2 as shown in FIG. 2 in interaction with the image interweaving pattern of the views as shown in FIG. 7.

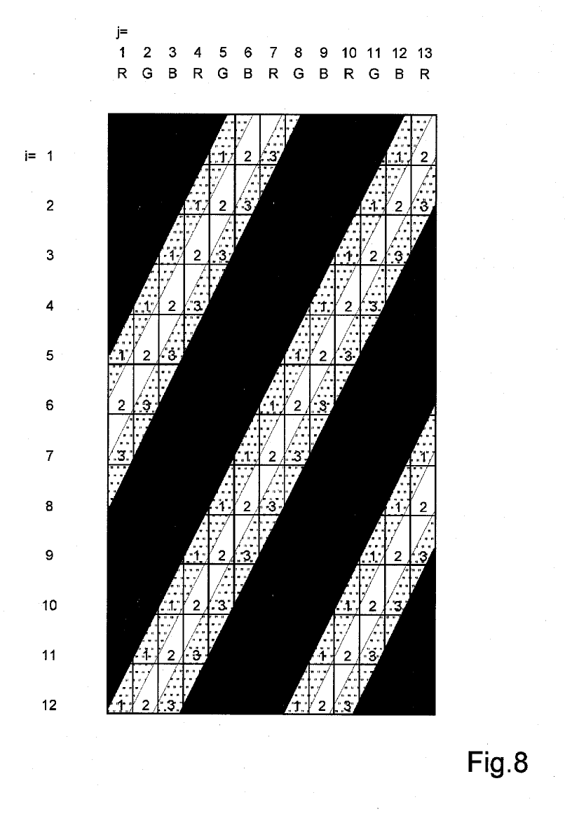

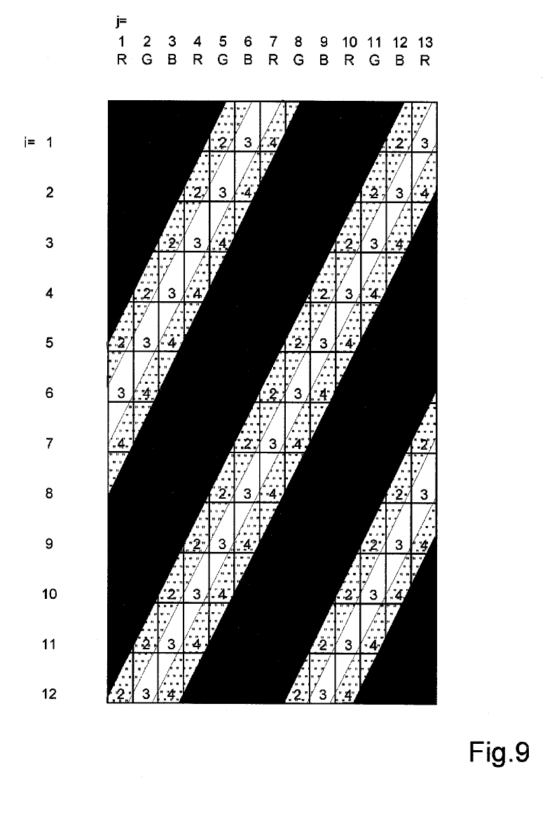

Because of the viewing restriction effected by the at least one parallax barrier screen 2, one or several viewers 3 will each see at least partially different pixels x(i,j) and/or parts thereof with each of their two eyes, so that each of the two eyes 3a, 3b perceives at least partially different views A(k), which results in a spatial visual impression. This is shown, for two different eye positions, in FIG. 8 and FIG. 9. Given the relationships according to FIG. 8, the eye would primarily see such pixels x(i,j) or parts thereof that show bits of partial information from the view A(2), i.e. k=2, and, in addition and with reduced brightness, such pixels x(i,j) that show the views A(1), A(3) and A(4) or parts thereof. Given the relationships according to FIG. 9, however, the eye would primarily see pixels x(i,j) or parts thereof that show bits of partial information from the view A(3), i.e. k=3, and, in addition and with reduced brightness, such pixels x(i,j) that show the views A(2), A(4) and A(5) or parts thereof.

The angle b (see. FIG. 7) that constitutes the said horizontal and vertical period length of the said two-dimensional periodic pattern as opposite leg and adjacent leg essentially corresponds to the average angle of inclination a of the transparent and the semitransparent segments on the parallax barrier screen 2 relative to the vertical (see FIG. 2). In this way, the best channel separation in 3D display is achieved.

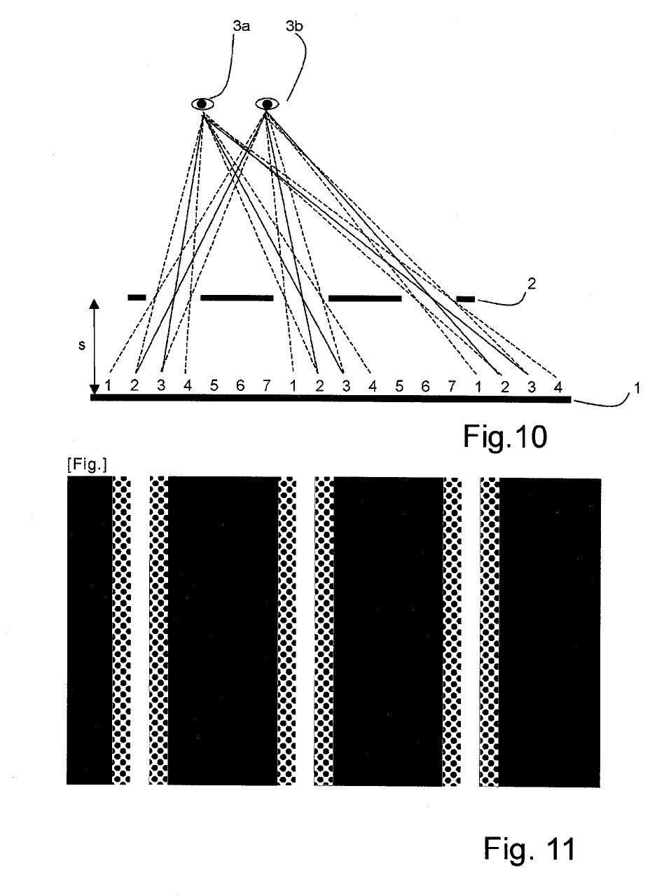

FIG. 10 illustrates another scheme of materialization of the spatial impression according to the invented method; the illustration is a cross-sectional, greatly simplified view. Here again it can be seen that the parallax barrier screen 2 is arranged at a distance s in front of the grid 1 of pixels x(i,j). Accordingly, the transparent or semitransparent segments of the parallax barrier screen 2 cause a viewing restriction effect in such a way that one or several viewers 3 see at least partially different pixels x(i,j) and/or parts thereof with each of their two eyes 3a, 3b, so that each of the two eyes 3a, 3b perceives at least partially different views A(k), which results in a spatial visual impression. This is indicated by the broken and solid lines: A solid line means that the light irradiated or transmitted by the pixels x(i,j) that are indicated on the drawing by numbers 1 through 7 (these numbers denoting the view A(k) from which the partial image information originates that is forwarded to the respective pixels) is essentially not attenuated when it passes a segment. The broken lines, on the other hand, mean that the respective light passes a semitransparent segment and is thereby attenuated in its intensity.

Here again, the relationships are as shown in FIG. 2 in interaction with the image interweaving pattern of the views according to FIG. 7, but, as described above, as a lateral cross-section.

Accordingly, the one eye 3b primarily sees such pixels x(i,j), or parts thereof, that show bits of partial information from the view A(2), i.e. k=2, and, in addition and with reduced brightness, such pixels x(i,j) that show the views A(1) and A(3) or parts thereof. By contrast, the eye 3a accordingly primarily sees such pixels x(i,j), or parts thereof, that show bits of partial information from the view A(3), i.e. k=3, and, in addition and with reduced brightness, such pixels x(i,j) that show the views A(2) and A(4) or parts thereof. Further views A(k) may possibly be partially visible. Appropriate image contents provided, the viewer 3 will thus have a spatial impression. With conventional methods without semitransparent segments, only the views A(2) and A(3) would be visible as a rule. By contrast, the new method provides for increased brightness without too great a measure of crosstalk between the views visible to each of the eyes 3a, 3b. In other words: The increase in brightness is attained without an excessive reduction in stereo contrast.

Just as with various other 3D display methods, the views A(k) correspond to different perspectives of a scene or object. The views A(k) may correspond to still images or sequences of moving images.

As the viewer's pair of eyes 3a, 3b move sideways, a soft transition between the views A(k) is guaranteed.

Advantageously, given parallel projection of the parallax barrier screen 2 onto the grid 1 of pixels x(i,j), the transparent and the semitransparent segments are essentially inclined by −90 . . . +90 (including 0) degrees from the vertical direction of the grid of pixels x(i,j) (see FIG. 2 through FIG. 6), the inclination of zero degrees being, of course, no true inclination but corresponding to the vertical direction. This case, however, is explicitly meant to be included in the coverage of the invention, as shown in FIG. 11.

The transparent segments may, on an average, have a width equal to, or different from that of the semitransparent segments. In advantageous embodiments, the sum of the semitransparent segments will be greater than that of the transparent segments, in order to achieve the best possible stereo channel separation, i.e., a reduced mix of different views A(k) per eye 3a, 3b.

The parameters for the parallax barrier screen 2 can be easily computed with the aid of the two equations (1) and (2) known from Kaplan's article mentioned at the beginning. This establishes all necessary relations between the distance s of the grid of pixels x(i,j) from the parallax barrier screen 2, the average human interpupillary distance (typically 65 mm), the viewing distance, the (horizontal) period length of the transparent or semitransparent segments of the barrier, and the possible stripe width of the said transparent or semitransparent segments.

The following should be noted regarding the period of the structure used on the parallax barrier screen 2: The said horizontal and vertical period length of the said two-dimensional periodic pattern (of arrangement of the views A(k) on the grid 1) should preferably agree with the respective horizontal and vertical period lengths of the transparent segments of the parallax barrier screen 2, save for a correction factor y, with 0.98<y<1.02. Where appropriate, the horizontal or vertical period length of the transparent segments may be understood to be the average horizontal or vertical distance, respectively, of the same.

The above explanations on the invented method in connection with the drawings FIG. 1 through FIG. 11 apply analogously to the arrangements according to the invention, with the grid 1 being implemented by an image display device, for example, a color LC display.

A suitable control unit for the image display device, such as a PC with software, is, of course, provided, though not shown on the drawings because of triviality.

The advantages of the invention are many and various. In particular, the invented method and the corresponding arrangements make possible an autostereoscopic display on the basis of the barrier technology, providing, as desired, improved perceptibility for several viewers simultaneously, especially due to reduced moiré effects. Improved perceptibility especially but not exclusively means improved brightness simultaneously with the best possible stereo channel separation.

The invention can be implemented by relatively simple means.

What is claimed is:

1. A method for spatial display, comprising
displaying bits of partial information from different views A(k), wherein k=1, . . . , n and n>1, on a grid of pixels x(i, j) with rows and columns, wherein i is a row number and j is a column number,
arranging at least one parallax barrier screen in front of or behind the grid of pixels x(i, j) at a distance “s”, the at least one parallax barrier screen comprising segments with different transmission behaviors delimited by edges, wherein at least one of the segments is semitransparent, and wherein each edge runs from one margin of the parallax barrier screen to an adjoining margin or to an opposite margin, and
the different transmission behaviors of segments of the at least one parallax barrier screen producing a spatial visual impression for one or several viewers, each of two eyes of each viewer seeing at least partially different pixels and/or parts thereof and perceiving at least partially different views of the views A(k).

2. The method of claim 1, wherein each segment is opaque, semitransparent, or transparent according to a periodic pattern.

3. The method of claim 1, wherein each segment is semitransparent or transparent according to a periodic pattern.

4. The method of claim 1, wherein the bits of partial information from different views A(k) on the grid of pixels x(i, j) are displayed in a two-dimensional periodic pattern, wherein a horizontal period length is not greater than 32 pixels and a vertical period length is not greater than 32 pixels.

5. The method of claim 4, wherein the vertical period length is equal to the number n of the views A(k).

6. The method of claim 1, wherein the pixels x(i, j) are color sub-pixels, each sub-pixel for a single color component, or clusters of color sub-pixels, or full-color pixels.

7. The method of claim 1, wherein the semitransparent segments are neutral density filters or neutral density step filters.

8. The method of claim 7, wherein the neutral density filters or neutral density step filters are made using dithering methods with exclusively opaque and transparent partial areas.

9. The method of claim 1, wherein at least one transparent segment is adjacent to a semitransparent segment on the parallax barrier screen.

10. The method of claim 4, wherein an angle corresponding to the horizontal period length and the vertical period length of the two-dimensional periodic pattern being, respectively, an opposite side and adjacent side is substantially equal to an average angle “a” of inclination of transparent and semitransparent segments on the parallax barrier screen relative to a vertical direction.

11. A device for spatial display, comprising:
an image display comprising pixels x(i, j) on a grid with rows and columns, wherein i is a row number and j is a column number, capable of displaying bits of partial information from different views A(k), wherein k=1, . . . , n and n >1,
at least one parallax barrier screen in front of or behind the grid of pixels x(i, j) at a distance “s”, the at least one parallax barrier screen comprising segments with different transmission behaviors delimited by edges, wherein at least one of the segments is semitransparent, and wherein each edge runs from one margin of the parallax barrier screen to an adjoining margin or to an opposite margin
wherein the different transmission behaviors of segments of the at least one parallax barrier screen produce a spatial visual impression for one or several viewers, each of two eyes of each viewer seeing at least partially different pixels and/or parts thereof and perceiving at least partially different views of the views A(k).

12. The device of claim 11, wherein the bits of partial information from different views A(k) on the grid of pixels x(i, j) are displayed in a two-dimensional periodic pattern, wherein a horizontal period length is not greater than 32 pixels and a vertical period length is not greater than 32 pixels.

13. The device of claim 12, wherein the vertical period length is equal to the number n of the views A(k).

14. The device of claim 11, wherein the pixels x(i, j) are color sub-pixels, each sub-pixel for a single color component, or clusters of color sub-pixels, or full-color pixels

15. The device of claim 11, wherein the semitransparent segments are neutral density filters or neutral density step filters.

16. The device of claim 15, wherein at least one of the semitransparent segments has a particular locus-dependent transmittance.

17. The device of claim 15, wherein the neutral density filters or neutral density step filters are made using dithering methods with exclusively opaque and transparent partial areas.

18. The device of claim 11, wherein at least one transparent segment is adjacent to a semitransparent segment on the parallax barrier screen.

19. The device of claim 11, wherein, in a parallel projection of the parallax barrier screen onto the grid of pixels x(i, j), the parallax barrier screen comprises transparent and semitransparent segments inclined between −90° and +90° relative to a vertical direction of the grid of pixels x(i, j).
